(19) United States
(12) Patent Application Publication
(10) Pub. No.: US 2023/0216432 A1
(43) Pub. Date: Jul. 6, 2023

(54) DEVICE AND METHOD FOR ENERGY GENERATION AND STORAGE

(71) Applicant: The Research Foundation for The State University of New York, Amherst, NY (US)

(72) Inventors: Jun LIU, Williamsville, NY (US); Thomas THUNDAT, Williamsville, NY (US); Kun-Hung TSAI, Amherst, NY (US)

(21) Appl. No.: 17/996,401

(22) PCT Filed: Apr. 19, 2021
(86) PCT No.: PCT/US2021/028032

§ 371 Date: Oct. 17, 2022

Related U.S. Application Data
(60) Provisional application No. 63/011,845, filed on Apr. 17, 2020.

(51) Int. Cl. H02N 1/04

(52) U.S. Cl. CPC H02N 1/04

(57) ABSTRACT

The present disclosure is directed to a direct-current (DC) mechanical energy harvesting and storage method and apparatus, which can convert mechanical energy such as environmental vibration, automobile kinetic energy, human body motion, etc. directly into 10 sustained DC electricity, and store the electricity in the same materials. More specifically, the disclosure relates to quantum mechanical tunneling of triboelectric charges through a semiconductor-based sliding unit or its integrated system, and the storage of the charges in the unit or its integrated system. A triboelectric generator and storage device includes a first contact member made from a first material. A second contact member is in slidable contact with the first contact member. The second contact member is made from a second material which forms a Schottky barrier with the first material.

### CROSS-REFERENCE TO RELATED APPLICATIONS

This application claims priority to U.S. Provisional Application No. 63/011,845, filed on Apr. 17, 2020, now pending, the disclosure of which is incorporated herein by reference.

### FIELD OF THE DISCLOSURE

The present disclosure is directed to a direct-current (DC) mechanical energy harvesting and storage method and apparatus, which can convert mechanical energy such as environmental vibration, automobile kinetic energy, human body motion, etc. directly into sustained DC electricity, and store the electricity in the same materials. More specifically, the disclosure relates to quantum mechanical tunneling of triboelectric charges through a semiconductor-based sliding unit or its integrated system, and the storage of the charges in the unit or its integrated system.

### BACKGROUND OF THE DISCLOSURE

Mechanical energy harvesting materials and systems have emerged as a promising research area because of the widespread and growing demand for powering wireless sensor networks, wearable devices, and rechargeable energy storage systems. Generating sufficient current density for powering electronic devices remains as one of the critical challenges for previous devices based on piezo and triboelectricity, mainly due to the high impedance of the insulating material systems.

Traditionally, triboelectric nanogenerators (TENGs) operate based on contact electrification and charge induction, where two contact materials (metal-insulator or insulator-insulator) are utilized. Although high voltage can be obtained by the resulting electrostatic charges, there is no direct charge flow and conduction in the insulating system. In order to achieve the current flow in the circuit, the capacitor system is oscillated vertically or horizontally by mechanical motion, thereby generating dielectric displacement current. The as-generated current is in the alternative current (AC) form with low current density, due to the high impedance of the insulating system.

The current output of previous devices exhibit transient, impulse features at low mechanical frequency, which cannot provide continuous and sustained power generation, unless special device configurations or high frequency mechanical energy sources are included.

Because previous devices based on piezoelectric effect or conventional triboelectric effect can only produce AC power output. In order to convert the AC to DC for practical applications, the use of rectification or special configuration such rotating disc structure is inevitable for the prior arts.

Additionally, previous devices require the use of separate energy storage devices, such as batteries or superconductors, to store the generated energy. Thus, in prior art systems, the functions of energy harvesting and energy storage were achieved separately in time and space.

Accordingly, there exists a need for a method and apparatus for harvesting mechanical energy into DC electricity with sustained and high current density output, as well as the ability for energy harvesting and storage in a single device.

### BRIEF SUMMARY OF THE DISCLOSURE

The present disclosure describes a method and apparatus for direct-current (DC) mechanical energy harvesting and storage. In one embodiment of the present disclosure, a device having a frictional interface is provided, and triboelectric charges generated at the frictional interface are harvested by quantum mechanically tunneling. This provides a system which can generate and store energy which can be provided as useful direct current electricity. Under open-circuit conditions, the as-generated charge can be accumulated and stored in the system, and subsequently released in the form of DC output when connected to an electrical load.

In particular embodiments, a three-layer unit has a first contact member made from a first material that can either be conducting or semiconducting. A second contact member is in slidable contact with the first contact member. The second contact member is made from a semiconductor material that allows the triboelectric charges to quantum mechanically tunnel through the heterojunction interface and be conducted inside (through) the second contact member in the DC form, rather than being electrostatically trapped at the surface of the second contact member. Simultaneously, the second contact member can serve as an energy storage system for charge accumulation. A third layer may be an electrode in Ohmic contact with the second contact member. The as-generated current is in DC form with high current density, which can be readily used or stored in-situ without any rectification.

In particular, according to various embodiments, the apparatus may include an integrated energy harvesting and storage system that comprises one or more of the energy generating/storing devices. As such, the current output or voltage output can be increased by series connection or parallel connection of the tribo-tunneling units, respectively.

### DESCRIPTION OF THE DRAWINGS

For a fuller understanding of the nature and objects of the disclosure, reference should be made to the following detailed description taken in conjunction with the accompanying drawings.

FIGS. 1A-1B illustrates schematic diagram of two representative embodiments.

FIGS. 2E and 2F is an open-circuit voltage output and a short-circuit current output of one embodiment, respectively, under the linear reciprocal mode in a repeated sequence as shown in FIGS. 2A-2D. FIG. 2G is a short-circuit current output as a function of insulator thickness.

FIGS. 3C and 3D is an open-circuit voltage output and a short-circuit current output of one embodiment, respectively, under the continuous friction mode in a repeated sequence as shown in FIGS. 2A-2B.

FIG. 4 is an in-situ mechanical energy storage in one embodiment and its discharging behavior under short-circuit condition. Zone I: charging with embodiment in FIG. 3B under circular motion mode (open-circuit). Energy are stored in the embodiment; Zone II: discharging curve under static condition (short-circuit).

FIG. 5A is a schematic diagram of an exemplary array of embodiments according to the invention electrically connected in in series. FIG. 5B is a schematic diagram of an array of embodiments according to the invention electrically connected in parallel. FIG. 5C is a schematic diagram where, according to the invention, of arrays of embodiments electrically connected in series are electrically connected in parallel.

FIG. 6 is a chart depicting a method according to another embodiment of the present disclosure.

### DETAILED DESCRIPTION OF THE DISCLOSURE

Various embodiments of the present disclosure are described more fully hereinafter with reference to the accompanying drawings, in which some, but not all embodiments of the disclosure are shown in the figures. The disclosure may be embodied in many different forms and should not be construed as limited to the embodiments set forth herein.

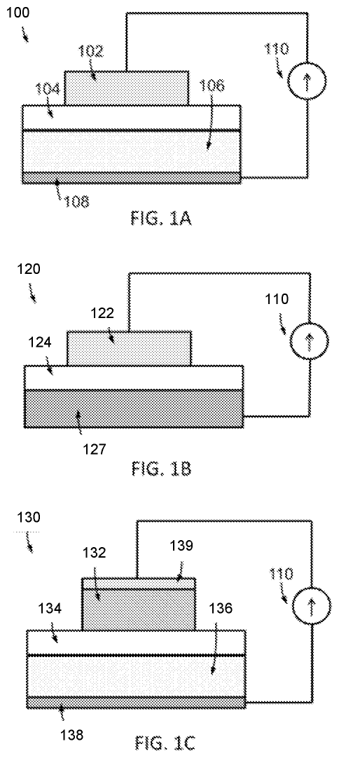

With reference to FIG. 1A, the present disclosure may be embodied as a tribo-tunneling direct-current generator 100. The generator 100 includes a first contact member 102 made from a first material. The first material may be a conducting material such as, for example, a metal, a metal alloy, a conducting composite, etc., or a semiconducting material such as, for example, doped silicon, etc., or combinations of materials. The first contact member 102 may have various shapes including, for example, a tip-shape, a pyramid, a plate, nanoparticles, etc. A second contact member 104 is in slidable contact with the first contact member 102. The second contact member is made from a second material, which is selected to form a Shottky barrier with the first material. For example, the second contact member may be made from materials including, for example, a semiconducting material, which allows triboelectric charges to quantum mechanically tunnel through the heterojunction interface and be conducted inside the layer (i.e., through the second contact member) in the DC form, rather than being electrostatically trapped at the surface of the second contact member. Simultaneously, the second contact member can serve as an energy storage system for charge accumulation.

In some embodiments, the second contact member can include an insulator, such as, for example, a dielectric material, such as SiO₂, TiO₂, Al₂O₃, a polymer, etc., which exhibits a different surface electrical potential value with respect to that of the first contact member, indicating a propensity to gain or lose electrons due to a contacting event (e.g., contact between the second contact member and the first contact member).

In some embodiments, the generator 100 further includes a substrate 106 on which the second contact member 104 is disposed. In some embodiments, a second electrode 108 is in Ohmic contact with the substrate (see, e.g., FIGS. 1A and 1C). In other embodiments, the second contact member may be disposed on a second electrode (e.g., the substrate may be conductive and thus considered a second electrode) (see, e.g., FIG. 1B). In some embodiments, the substrate 106 may be made from semiconducting materials such as, for example, doped silicon, conducting polymer, etc. The second electrode 108 is made from a conducting material, such as, for example, a metal, a metal alloy, a conducting composite, etc. In some embodiments (for example, the generator 120 of FIG. 1B), the second contact member 124 is disposed on a conducting material such as, for example, a metal, a metal alloy, a conducting composite, etc., forming a second electrode 127 (e.g., the second contact member also serves as the second electrode). The first contact member 122 is in sliding contact with the second contact member 124.

The thickness of second contact member 104 is selected such that electrons or holes generated by friction with the first contact member can quantum mechanically tunnel from the contact interface between the first contact member 102 and the second contact member 104, through the thickness of the second contact member to reach a substrate (e.g., substrate 106) or an electrode (e.g., electrode 108). For example, the thickness of the second contact member 104 may be within the range of from 1 nm to 100 nm (inclusive), though embodiments may include thicknesses that are less than 1 nm or more than 100 nm. For example, the second contact member may have a thickness of 1, 2, 3, 4, 5, 10, 20, 30, 50, 80, or 100 nm.

In some embodiments, the first contact member may include a semiconducting material such as, for example, doped silicon, etc. In a particular example, the first contact member (first material) may be a p-type semiconductor, and the second contact member (second material) may be an n-type semiconductor. In such embodiments (see, e.g., FIG. 1C), a generator 130 may have a first electrode 139 in Ohmic contact with the first contact member 132. The first electrode 139 may be made from a conducting material such as, for example, a metal, a metal alloy, a conducting composite, etc. The generator 130 of FIG. 1C is shown with a second contact member 134 disposed on a substrate 136, which is in ohmic contact with a second electrode 138. Other arrangements are possible and within the scope of the present disclosure.

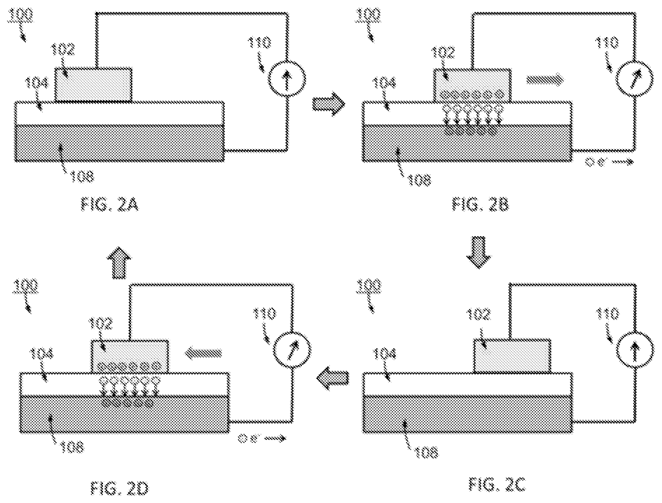

The working principle of previous triboelectric generators is based on contact electrification and charge induction, where there are only electrostatic surface charges generated from the contact event, and current generation is achieved by dielectric displacement alternating current (AC). In sharp contrast to such previous generators, a tribo-tunneling direct-current (DC) generator according to the present disclosure works based on quantum mechanical tunneling of charges through a dielectric layer. FIGS. 2A-2D illustrate direct-current electricity generation using an exemplary embodiment of a tribo-tunneling direct-current generator 100 according to an embodiment of the present disclosure. When the first contact member 102 is placed against the second contact member 104, as shown in FIG. 2A, triboelectric charge transfer may take place at the interface, but no conspicuous open-circuit voltage can be obtained. This is attributed to the insufficient thickness of the dielectric layer 104, for example, on the order of 1 nm to 100 nm such that a voltage cannot be built-up across the second contact member 104. When a lateral force is applied to the first contact member 102, an open-circuit voltage is generated (FIG. 2E), associated with a dynamic, non-equilibrium interfacial electronic structure. As shown in FIG. 2E, lateral back and forth sliding motion of the first contact member (with respect to the second contact member), irrespective of the direction of motion, generates a pulsed voltage output on an identical direction under an open-circuit condition. This voltage output ceases immediately upon stopping the movement of the first contact member 102 against the second contact member 104. Simultaneously, a direct-current can be generated when the electrical circuit is shorted (FIG. 2F). As shown in FIG. 2F, lateral back and forth sliding motion of the tip, irrespective of the direction of motion, generates a pulsed direct-current output under a short-circuit condition. The power output depends on the resistance of electrical load connected to the generator 100.

In an exemplary embodiment of a generator, silicon oxide is deposited as the second contact member on the surface of a substrate made from p-type silicon. An aluminum metal coating serves as the second electrode (i.e., in Ohmic contact with the substrate). An iron probe serves as the first contact member. When a lateral force is applied to drive the iron probe (first contact member) in friction with the silicon oxide (second contact member), its corresponding short-circuit current output as a function of oxide thickness is shown in FIG. 2G. The exponential decay of current output with increasing oxide thickness is in accordance with the quantum mechanical tunneling of electrons through an ultrathin insulating layer.

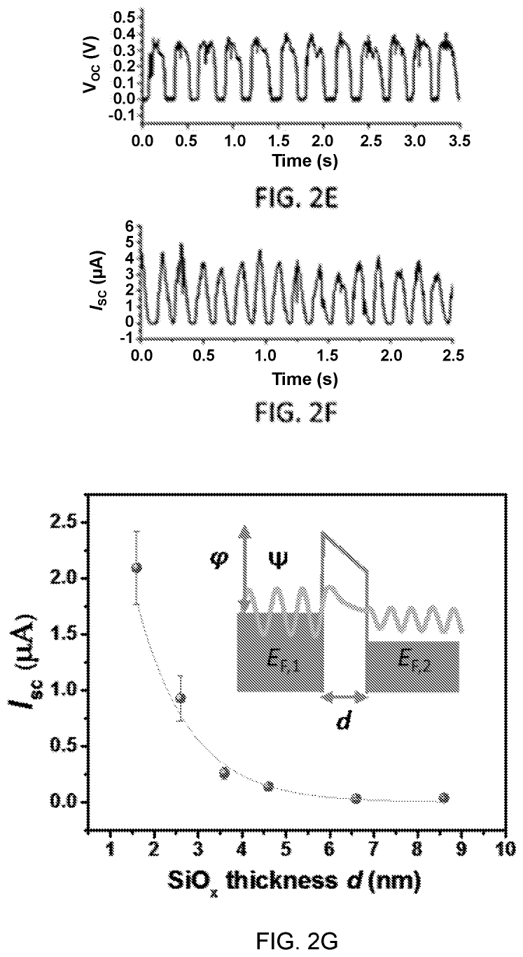

In another embodiment of generating direct-current electricity with generator 100, shown in FIGS. 3A-3B, the first contact member 102 and the second contact member 104 can be continuously rubbed against each other, such as, for example, in a circular motion. As shown in FIG. 3C, continuous sliding motion of the first contact member, irrespective of the direction of motion, generates a constant voltage output under an open-circuit condition. As shown in FIG. 3D, continuous sliding motion of the tip, irrespective of the direction of motion, generates a constant current output under a short-circuit condition. The power output depends on the resistance of electrical load connected to the generator 100.

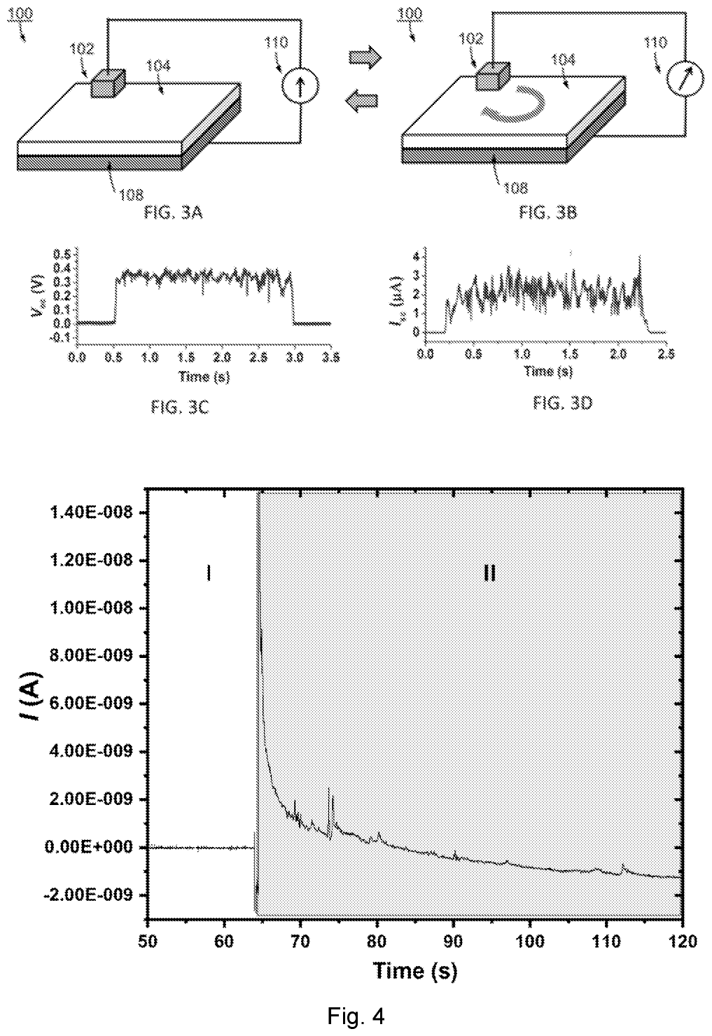

Embodiments of the presently-disclosed generator are configured to store a charge when in an open-circuit configuration. FIG. 4 is a graph showing the mechanical generation and storage of a charge (Zone 1), and subsequent release of the stored charge (Zone II). The first contact member 102 and the second contact member 104 can be rubbed against each other, such as, for example, in a circular or linear motion, to generate a charge. Under open-circuit conditions, as shown in Zone I, mechanical energy is converted into triboelectricity, and subsequently stored in the generator as contact members 102 and 104 form an energy storage system. When the relative movement is stopped, the charge can be stored in the generator. Under short-circuit conditions (i.e., having a load connected across the generator), the charges can be released, as shown in the Zone II in FIG. 4.

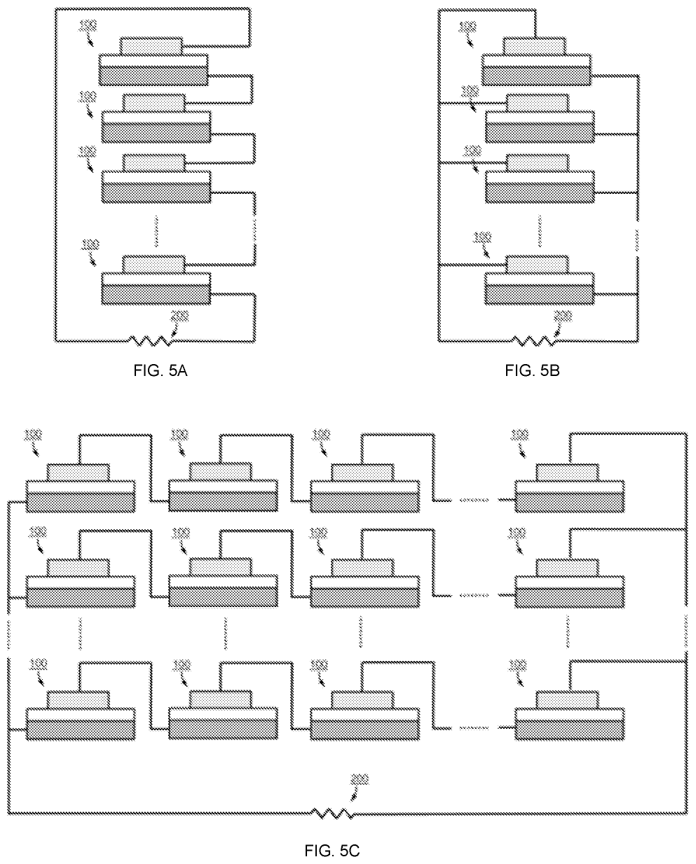

FIGS. 5A-5C illustrate various exemplary embodiments of systems comprising arrays of generators 100. In FIG. 5A, generators are connected in series (e.g., connecting a substrate of a generator to a first contact member of an adjacent generator). FIG. 5B illustrate generators connected in parallel (such that each first contact member is connected to each other first contact member, and each substrate is connected to each other substrate). FIG. 5C shows an embodiment with arrays of generators 100 connected in series, and each of these arrays are connected in parallel. A device 200 when connected to a generator 100 or an exemplary array of generators 100 can be electrically powered.

Embodiments of the present device may have many applications. For example, electric vehicles may take advantage of regenerative braking. In a disc brake configuration, the rotor may be a substrate having a second contact member and the brake pad may be a first contact member (or vice versa). Other brake configurations may be useful such as a drum configuration, etc. The present disclosure may be embodied as a vehicle mechanical energy device and having a generator of any of the embodiments described herein. The present disclosure may be embodied as a space mission power supply having a generator of any of the embodiments described herein. The present disclosure may be embodied as a vibration energy capture device having a generator of any of the embodiments described herein. The present disclosure may be embodied as a friction energy capture device having a generator of any of the embodiments described herein. The present disclosure may be embodied as a photoacoustic wave energy capture device having a generator of any of the embodiments described herein.

A device according to the present disclosure may be incorporated into a wave energy generator, wherein the first contact member and/or second contact member is moved (relative to the other contact member) by wave action. In another example, a wind energy generator can incorporate a present device such that wind action provides relative motion between the first contact member and the second contact member. These are non-limiting exemplary applications, and other actions of fluids may be harnessed to generate energy using embodiments of the presently-disclosed device. Such action can cause directional (e.g., back-and-forth) movement between the contact members, rotational motion (e.g., disks, cylinders, etc.), or any other configuration which provides relative sliding movement between the first and second contact members.

The ability of the presently-disclosed device to store energy in addition to generating energy provides important advantages over previous technologies. In another exemplary application, a sensor or sensor network may incorporate an embodiment of the present device. For example, a sensor used to measure temperature, salinity, turbidity, etc. of a body of water may utilize fluidic motion in its environment such that the sensor is self-powered. In such a device, the self-storage aspects of the generator can provide power during times when, for example, the ambient environment is still (e.g., calm days with little wave action, etc.) Such a device may be embodied as a fluidic flow energy capture device (e.g., a wave energy device, a wind energy device, etc.) comprising any of the generator embodiments described herein.

In another embodiment, the present disclosure may be a biomechanical motion energy capture device incorporating a generator according to any of the embodiments described herein. For example, a wearable device may harness body motion in order to power itself. In a particular example of a wearable device, a wristwatch may capture body motion using the triboelectric generator to power itself. In another biomechanical application, an implantable medical device may incorporate a generator to power itself

Other applications include a vibration energy capture device for converting vibrational motion into electrical energy. Examples of such applications include motors, generators, vehicles, and structures that incorporate a generator of the present disclosure for generating electrical energy. In a particular example, a device may be configured to capture structural energy, such as, for example, the vibrations that may exist within a building. In other applications, devices may include a generator to capture energy caused by friction in a system. For example, as mentioned above, regenerative braking in vehicles may incorporate a triboelectric generator to capture the frictional energy.

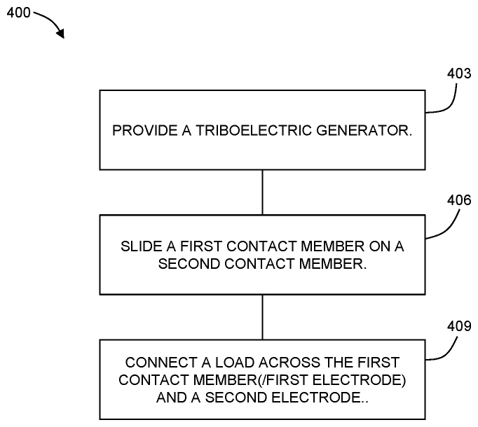

With reference to FIG. 6, in another aspect, the present disclosure may be embodied as a method 400 of generating an electrical potential difference. The method 400 includes providing 403 a generator (or multiple generators) according to any of the embodiments described herein. The method include sliding 406 a first contact member on a second contact member. In this way, an interface between the first contact member and the second contact member is excited and a charge is generated at the excited interface. The charge tunnels through the second contact member and produces an electrical potential difference. Based on the sliding motion, the electrical potential is a DC voltage.

It should be noted that the term “short circuit” is used herein to describe a connection that is not an open circuit. In other words, a short circuit may include direct connection of two points, or connection using, for example, resistor(s), coils, active components, and/or any other components, which does not result in an open circuit (i.e., no current flow). In various embodiments, “rubbing,” “sliding,” “moving,” etc., are terms used to indicate moving the first contact member relative to the second contact member (or vice versa) while maintaining contact between the two elements. Pressure between the first contact member and the second contact member may be selected according to a particular application and may be constant or may vary. The sizes of each of the first contact member and the second contact member may be selected according to a particular application and may be of any size. The first contact member and the second contact member may have the same size or different sizes from one another. By size, it is intended to refer to the lateral size of each element—i.e., relevant to a contact area between the first contact member and the second contact member. Discussions regarding size may have other meanings in other portions of the present disclosure.

The following are further non-limiting examples:

Example 1.A triboelectric generator and storage device, having a first contact member made from a first material; and a second contact member in slidable contact with the first contact member, and wherein the second contact member is made from a second material forming a Schottky barrier with the first material.

Example 2. The device of Example 1, wherein the first material is a conductor material or a semiconductor material.

Example 3. The device of Example 3, wherein the first material includes a metal, a metal alloy, a conducting composite, or a semiconducting material.

Example 4. The device of any of Examples 1-3, wherein the first contact member includes a tip, and wherein the tip of the first contact member is disposed on the second contact member in a point-plane configuration, wherein Schottky contact exists between the tip of the first contact member and the second contact member.

Example 5. The device of any of Examples 1-3, wherein the first contact member includes a surface, and wherein the surface of the first contact member is disposed on the second contact member in a plane-plane configuration, wherein Schottky contact exists between the surface of the first contact member and the second contact member.

Example 6. The device of Example 5, wherein the surface of the first contact member is a planar surface.

Example 7. The device of any of Examples 1-6, wherein the second contact member includes an insulator on a surface in contact with the first contact member.

Example 8. The device of Example 7, wherein the insulator is a dielectric

material.

Example 9. The device of any of Examples 7-8, wherein the insulator is an oxide layer on the second contact member.

Example 10. The device of any one of Examples 1-9, wherein the second material includes silicon, molybdenum disulfide, silicon dioxide, titanium dioxide, aluminum oxide, or a polymer.

Example 11. The device of any of Examples 1-10, wherein the second contact member has a thickness of 1-100 nm, inclusive.

Example 12. The device of any one of Examples 1-11, further including a second electrode in Ohmic contact with the second contact member.

Example 13. The device of any one of Examples 1-11, further including a substrate on which the second contact member is disposed.

Example 14. The device of Example 13, wherein the substrate is made from a semiconductor material, such as, a p-type doped material, an n-type doped material, a conducting polymer, etc.

Example 15. The device of any of Examples 13-14, wherein the substrate includes an organic material, an inorganic material, or an organic/inorganic composite material.

Example 16. The device of any of Examples 13-15, further including a second electrode in Ohmic contact with the substrate.

Example 17. The device of any of Examples 1-14, wherein one or more of the first contact member, the second contact member, and the substrate are flexible.

Example 18. The device of any of Examples 1-15, wherein the first contact member and/or the second contact member is flexible and includes a semiconducting polymer, a graphene-polymer nanocomposite, or a perovskite material.

Example 19. A system including a plurality of devices of any of Examples 1-18.

Example 20. The system of Example 19, wherein the plurality of devices are arranged in parallel.

Example 21. The system of Example 19, wherein the plurality of devices are arranged in series.

Example 22. The system of Example 19, wherein a first portion of the plurality of devices are arranged in two or more serial subsets, and the two or more subsets are arranged in parallel; or a first portion of the plurality of devices are arranged in two or more parallel subsets, and the two or more subsets are arranged in serial.

Example 23. A method of generating an electrical potential difference, including providing a device according to any one of Examples 1-22; and sliding the first contact member, thereby exciting an interface between the first contact member and the second contact member, thereby generating a charge at the interface, the charge tunneling through the second contact member and producing the electrical potential difference between the first contact member and the semiconductor substrate.

Example 24. The method of Example 23, wherein the electrical potential difference is output as direct current.

Example 25. The method of Example 24, wherein the direct current output has a current density of 10 to 100 A/m².

Example 26. The method of any of Examples 23-25, further including storing energy in a battery or capacitor using the direct current output.

Example 27. The method of any of Examples 23-26, further including storing energy in the device using the direct current output.

Example 28. The method of any of Examples 23-27, wherein the sliding is linear motion, rotational motion, a combination of linear and rotation motion, other motion, or random motion.

Example 29. A fluidic flow energy capture device including the device of any of Examples 1-22.

Example 30. A vehicle mechanical energy device including a device of any one of Examples 1-22.

Example 31. A sensor including a device of any one of Examples 1-22.

Example 32. A biomechanical motion energy capture device including the device of any of Examples 1-22.

Example 33. A space mission power supply including the device of any of Examples 1-22.

Example 34. A vibration energy capture device including the device of any of Examples 1-22.

Example 35. A friction energy capture device including the device of any of Examples 1-22.

Example 36. A photoacoustic wave energy capture device including the device of any of Examples 1-22.

Although the present disclosure has been described with respect to one or more particular embodiments, it will be understood that other embodiments of the present disclosure may be made without departing from the spirit and scope of the present disclosure.

We claim:

1. A triboelectric generator and storage device, comprising:
a first contact member made from a first material; and
a second contact member in slidable contact with the first contact member, and wherein the second contact member is made from a second material forming a Schottky barrier with the first material.

2. The device of claim 1, wherein the first material is a conductor material or a semiconductor material.

3. The device of claim 3, wherein the first material comprises a metal, a metal alloy, a conducting composite, or a semiconducting material.

4. The device of claim 1, wherein the first contact member comprises a tip, and wherein the tip of the first contact member is disposed on the second contact member in a point-plane configuration, wherein Schottky contact exists between the tip of the first contact member and the second contact member.

5. The device of claim 1, wherein the first contact member comprises a surface, and wherein the surface of the first contact member is disposed on the second contact member in a plane-plane configuration, wherein Schottky contact exists between the surface of the first contact member and the second contact member.

6. The device of claim 5, wherein the surface of the first contact member is a planar surface.

7. The device of claim 1, wherein the second contact member includes an insulator on a surface in contact with the first contact member.

8. The device of claim 7, wherein the insulator is a dielectric material.

9. The device of claim 7, wherein the insulator is an oxide layer on the second contact member.

10. The device of claim 1, wherein the second material comprises silicon, molybdenum disulfide, silicon dioxide, titanium dioxide, aluminum oxide, or a polymer.

11. The device of claim 1, wherein the second contact member has a thickness of 1-100 nm, inclusive.

12. The device of claim 1, further comprising a second electrode in Ohmic contact with the second contact member.

13. The device of claim 1, further comprising a substrate on which the second contact member is disposed.

14. The device of claim 13, wherein the substrate is made from a semiconductor material, such as, a p-type doped material, an n-type doped material, a conducting polymer, etc.

15. The device of claim 13, wherein the substrate comprises an organic material, an inorganic material, or an organic/inorganic composite material.

16. The device of claim 13, further comprising a second electrode in Ohmic contact with the substrate.

17. The device of claim 1, wherein one or more of the first contact member, the second contact member, and the substrate are flexible.

18. The device of claim 1, wherein the first contact member and/or the second contact member is flexible and comprises a semiconducting polymer, a graphene-polymer nanocomposite, or a perovskite material.

19. A system comprising a plurality of devices of any of claims 1-18.

20. The system of claim 19, wherein the plurality of devices are arranged in parallel.

21. The system of claim 19, wherein the plurality of devices are arranged in series.

22. The system of claim 19, wherein a first portion of the plurality of devices are arranged in two or more serial subsets, and the two or more subsets are arranged in parallel; or a first portion of the plurality of devices are arranged in two or more parallel subsets, and the two or more subsets are arranged in serial.

23. A method of generating an electrical potential difference, comprising:
providing a device according to any one of claims 1-22; and
sliding the first contact member, thereby exciting an interface between the first contact member and the second contact member, thereby generating a charge at the interface, the charge tunneling through the second contact member and producing the electrical potential difference between the first contact member and the semiconductor substrate.

24. The method of claim 23, wherein the electrical potential difference is output as direct current.

25. The method of claim 24, wherein the direct current output has a current density of 10 to 100 A/m².

26. The method of claim 23, further comprising storing energy in a battery or capacitor using the direct current output.

27. The method of claim 23, further comprising storing energy in the device using the direct current output.

28. The method of claim 23, wherein the sliding is linear motion, rotational motion, a combination of linear and rotation motion, other motion, or random motion.

29. A fluidic flow energy capture device comprising the device of any of claims 1-22.

30. A vehicle mechanical energy device comprising a device of any one of claims 1-22.

31. A sensor comprising a device of any one of claims 1-22.

32. A biomechanical motion energy capture device comprising the device of any of claims 1-22.

33. A space mission power supply comprising the device of any of claims 1-22.

34. A vibration energy capture device comprising the device of any of claims 1-22.

35. A friction energy capture device comprising the device of any of claims 1-22.

36. A photoacoustic wave energy capture device comprising the device of any of claims 1-22.
